(19) United States
(12) Patent Application Publication
(10) Pub. No.: US 2024/0230461 A1
(43) Pub. Date: Jul. 11, 2024

(54) OPTICAL MONITOR DEVICE

(71) Applicant: NIPPON TELEGRAPH AND TELEPHONE CORPORATION, Tokyo (JP)

(72) Inventors: Ryo KOYAMA, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/288,989

(22) PCT Filed: May 28, 2021
(86) PCT No.: PCT/JP2021/020451

§ 371 Date: Oct. 30, 2023

(51) Int. Cl. G01M 11/02

(52) U.S. Cl. CPC G01M 11/0207

(57) ABSTRACT

An object of the present disclosure is to realize a compact and low-cost optical monitoring device capable of accurately measuring the power of an optical signal regardless of the polarization state of an incident optical signal for a multi-core optical fiber.

An optical monitoring device according to the present disclosure includes: a first branching portion that branches incident light incident from a determined incident area into two in a first direction and a second direction; a first light receiving element that receives branched light branched in the second direction by the first branching portion and detects an intensity of the light branched by the first branching portion for each incident position in the incident area; a second branching portion that branches branched light branched in the first direction by the first branching portion into two in a third direction perpendicular to both the first direction and the second direction and the first direction; and a second light receiving element that receives branched light branched in the third direction by the second branching portion and detects an intensity of the light branched by the second branching portion for each incident position in the incident area.

### TECHNICAL FIELD

The present disclosure relates to an optical monitoring device, and more particularly to an optical monitoring device for detecting the intensity of light and feeding back results of the detection to other components in an optical transmission device or the like.

### BACKGROUND ART

In recent years, as Internet traffic has increased, there has been a strong demand for increased communication capacity in communication systems. In order to meet this demand, communication systems using optical fibers have been used in access networks between a communication station building and a user's house or in core networks connecting communication station buildings. In optical fiber communication, detection of the intensity of light propagating through an optical fiber is often used to control communication and to check the soundness of equipment. For example, in access networks, test light is propagated through an optical fiber, and the light intensity of the test light is detected to check the loss and soundness of the optical fiber, as well as the target and connections of the core wires. Further, in wavelength division multiplexing (WDM) transmission used in core networks, it is necessary to monitor light intensity for feedback control.

In light intensity monitoring of access networks, a technique for branching light at a constant branching ratio by two parallel waveguides is used (see, for example, PTL 1), which enables measurement of the intensity and propagation loss of optical signals in access networks.

In light intensity monitoring in WMD transmission, a technique for simultaneously monitoring the intensity of optical signals of a plurality of optical fibers by a combination of one-dimensionally arranged optical fibers and a dielectric multilayer film is used (see, for example, PTL 2).

However, the optical monitoring device having the conventional arrangement still has the following problems.

While optical communication is widely used and the number of cores of fibers in optical equipment/cables has increased, the cost and size of an optical monitoring device using an optical coupler for each optical fiber increase in accordance with the increase in the number of cores of fibers. Even in the case of an optical monitoring device in which optical fibers and optical intensity sensors are arranged in a one-dimensional array, there is a limit in the array-arrangement of the optical fibers, and if the number of cores of the optical fibers increases beyond that limit, the cost and size increase in accordance with the number of cores.

There is also a technique using Fresnel reflection as a spatial optical system for constituting such an optical monitoring device. However, since Fresnel reflection has different reflectances depending on incident p-polarized light and s-polarized light, there is a problem that the branching ratio of the light branched to the optical sensor side changes depending on the polarization state of the incident light, and accurate measurement cannot be performed.

### CITATION LIST

### Patent Literature

[PTL 1] Japanese Patent No. 3450104
[PTL 2] Japanese Patent Application Publication No. 2004-219523

### SUMMARY OF INVENTION

### Technical Problem

The present disclosure has been made in view of such points, and an object of the present disclosure is to realize a compact and low-cost optical monitoring device capable of accurately measuring the power of an optical signal regardless of the polarization state of an incident optical signal for a multi-core optical fiber, such as several tens of cores.

### Solution to Problem

In order to achieve the object described above, an optical monitoring device of the present disclosure is an optical monitoring device that detects an intensity of light propagating through a plurality of optical fibers, the optical monitoring device including:
a first branching portion that branches incident light incident from a determined incident area into two in a first direction and a second direction;
a first light receiving element that receives branched light branched in the second direction by the first branching portion and detects an intensity of the light branched by the first branching portion for each incident position in the incident area;
a second branching portion that branches branched light branched in the first direction by the first branching portion into two in a third direction perpendicular to both the first direction and the second direction and the first direction; and
a second light receiving element that receives branched light branched in the third direction by the second branching portion and detects an intensity of the light branched by the second branching portion for each incident position in the incident area.

### Advantageous Effects of Invention

According to the present disclosure, a compact and low-cost optical monitoring device capable of accurately measuring the power of an optical signal regardless of the polarization state of an incident optical signal for a multi-core optical fiber, such as several tens of cores can be realized.

### BRIEF DESCRIPTION OF DRAWINGS

FIG. 1 is a diagram illustrating a relationship between incident angle and reflection of s-polarized light and p-polarized light.

FIG. 2 is a diagram illustrating an optical monitoring device according to the present disclosure.

FIG. 3 is a diagram illustrating the optical monitoring device according to the present disclosure.

FIG. 4 is a diagram illustrating the optical monitoring device according to the present disclosure.

FIG. 5 is a diagram illustrating states of light at first and second refractive index interfaces.

FIG. 6 is a diagram illustrating states of light at third and fourth refractive index interfaces.

FIG. 7 is a diagram illustrating states of light at first and second refractive index interfaces.

FIG. 8 is a diagram illustrating states of light at third and fourth refractive index interfaces.

FIG. 9 is a diagram illustrating states of light at third and fourth refractive index interfaces.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

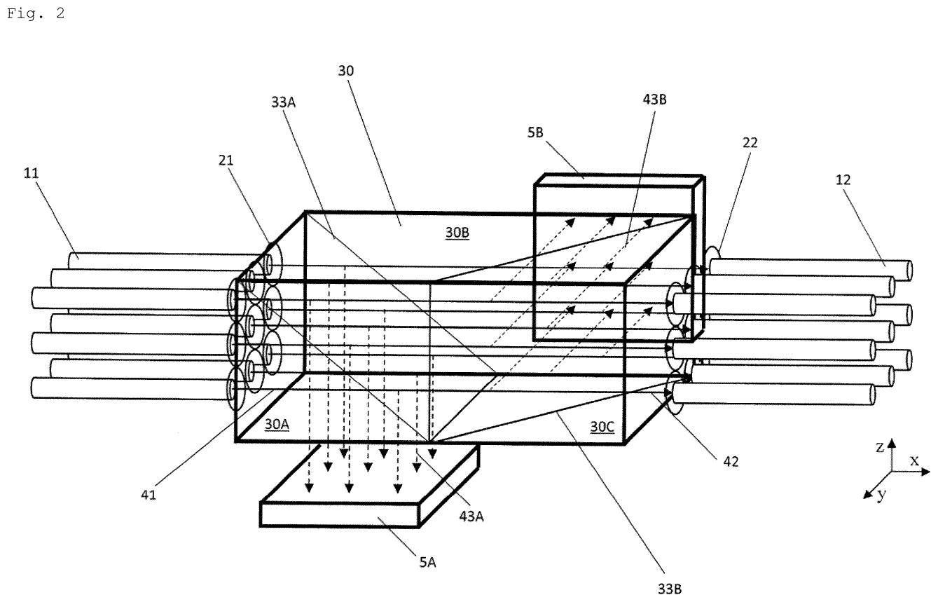

In order to solve the above problems, the present disclosure provides an optical monitoring device that can be realized by the configuration illustrated in FIG. 2.

An optical monitoring device of the present disclosure includes:
a spatial optical system 30 that branches and emits part of incident light 41 in a specific direction (second direction), part of the rest in another specific direction (third direction), and most of the rest in still another specific direction (first direction) at a specific branching ratio; an incident side optical fiber 11 that propagates a plurality of light beams arranged in a two-dimensional array so as to make light incident on the spatial optical system 30; an emission side optical fiber 12 that propagates a plurality of light beams arranged so as to receive most of emitted light 42 from the spatial optical system 30;
a first light receiving element 5A arranged so as to receive a first part of emitted light 43A from the spatial optical system 30;
a second light receiving element 5B arranged so as to receive a second part of emitted light 43B;
an incident side optical lens 21 that is arranged between the spatial optical system 30 and the incident side optical fiber 11 and makes incident light to the spatial optical system 30 into parallel light; and
an emission side optical lens 22 that is arranged between the spatial optical system 30 and the emission side optical fiber 12 and efficiently couples emitted light from the spatial optical system 30 to the emission side optical fiber 12.

As illustrated in FIG. 2, the spatial optical system 30 may include
a first member 30A that is connected to the incident side optical lens 21 and has a uniform refractive index,
a first single layer film 33A that is in contact with the first member 30A and has a uniform refractive index different from that of the first member 30A,
a second member 30B that is in contact with the first single layer film 33A and has the same refractive index as that of the first member 30A,
a second single layer film 33B that is in contact with the second member 30B and has the same refractive index as that of the first single layer film 33A, and
a third member 30C that is connected to the second single layer film 33B and the emission side optical lens 22 and has the same refractive index as that of the first member 30A.

Here, the refractive index of the first single layer film 33A and the refractive index of the second single layer film 33B are arbitrary. For example, the refractive index of the first single layer film 33A and the refractive index of the second single layer film 33B are lower than the refractive indices of the first member 30A, the second member 30B, and the third member 30C. The refractive index of the first single layer film 33A and the refractive index of the second single layer film 33B may be the same or different.

The first single layer film 33A functions as a first branching portion that branches incident light into two in a first direction and a second direction. The second single layer film 33B functions as a second branching portion that branches branched light branched in the first direction by the first single layer film 33A into two in a third direction perpendicular to both the first direction and the second direction and the first direction.

The spatial optical system 30 includes
a first refractive index interface 31A and a second refractive index interface 31B which are provided at a specific angle with respect to the optical axis of the incident light 41 and are parallel to each other, and a third refractive index interface 31C and a fourth refractive index interface 31D which are provided at the above-mentioned specific angle with respect to the optical axis of the incident light 41 and with normal lines orthogonal to normal lines of the first refractive index interface 31A and the second refractive index interface 31B and are parallel to each other,
a first direction in which most of the emitted light 42 is emitted is a direction in which the light passes through first to fourth refractive index interfaces (31A, 31B, 31C, and 31D),
a second direction in which the first part of the emitted light 43A is emitted is a direction in which the light is reflected by the first refractive index interface 31A, and a third direction in which the second part of the emitted light 43B is emitted is a direction in which the light is reflected by the third refractive index interface 31C.

Further, the spatial optical system 30 may include a first refractive index interface 31A and a second refractive index interface 31B which are provided at a specific angle with respect to the optical axis of the incident light 41 and are parallel to each other, and a third refractive index interface 31C and a fourth refractive index interface 31D which are arranged closer to the emission side optical fiber 12 than the first refractive index interface 31A and the second refractive index interface 31B and correspond to surfaces obtained by rotating the first refractive index interface 31A and the second refractive index interface 31B by 90 degrees in a circumferential direction around the optical axis of the incident light 41.

In FIG. 2, a boundary surface between the first member 30A and the first single layer film 33A is defined as a first refractive index interface 31A, a boundary surface between the second member 30B and the first single layer film 33A is defined as the second refractive index interface 31B, a boundary surface between the second member 30B and the second single layer film 33B is defined as a third refractive index interface 31C, and a boundary surface between the third member 30C and the second single layer film 33B is defined as a fourth refractive index interface 31D.

FIG. 2 and FIGS. 3 to 9 to be described later, illustrate examples in which the first direction is an x-axis direction, the second direction is a z-axis direction, and the third direction is a y-axis direction, but these directions can be set to arbitrary directions according to the optical design of the spatial optical system 30.

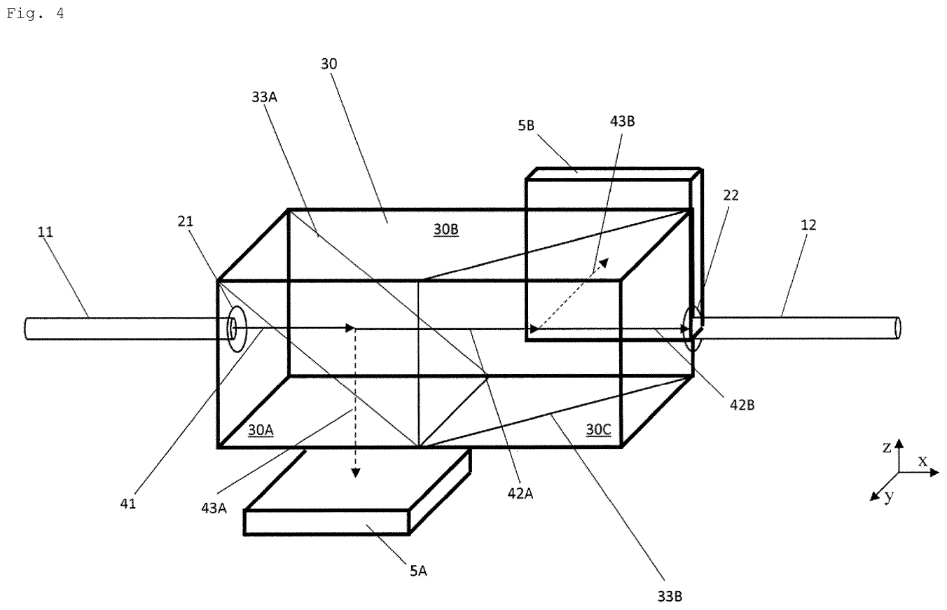

FIG. 4 illustrates only one of each of the two-dimensionally arranged incident side optical fibers 11 and emission side optical fibers 12 in order to facilitate understanding of the spatial optical system 30 illustrated in FIG. 2. Hereinafter, the light transmitted through the first single layer film 33A in the x-axis direction is regarded as most of emitted light 42A, and the light transmitted through the second single layer film 33B in the x-axis direction is regarded as most of emitted light 42B. Further, it is assumed that the optical axis of the incident light 41 is in the x-axis direction.

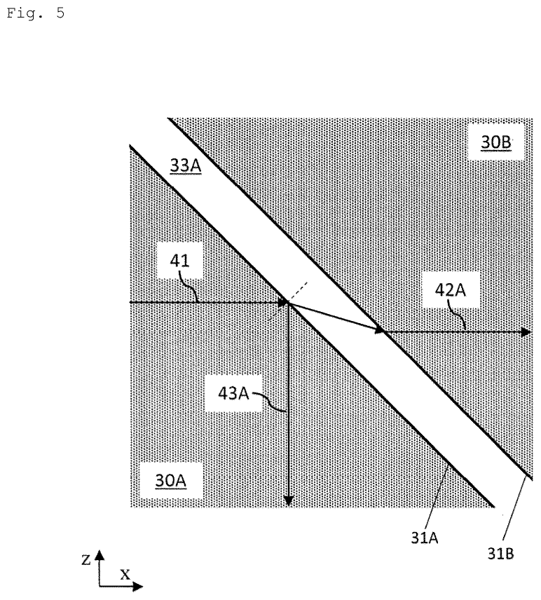

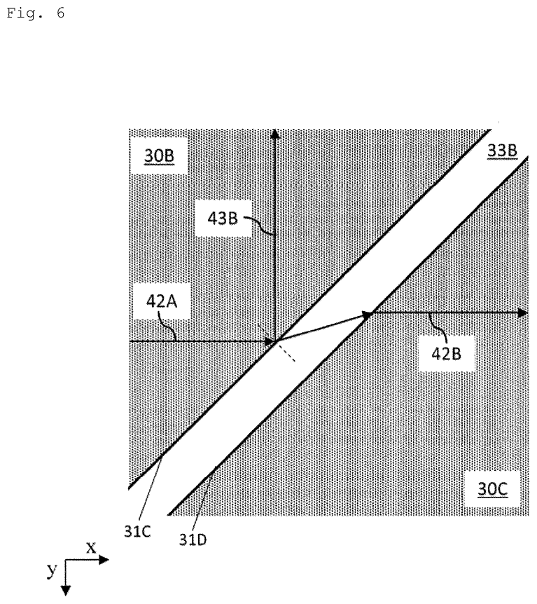

FIG. 5 illustrates a cross section (xz plane) including the incident light 41 and the first part of the emitted light 43A of the first single layer film 33A illustrated in FIG. 4. FIG. 6 illustrates a cross section (xy plane) including most of the emitted light 42A and the second part of the emitted light 43B of the second single layer film 33B illustrated in FIG. 4.

When the refractive indices of the member 30A and the single layer film 33A are different from each other, as illustrated in FIG. 5, part of the incident light 41 is reflected by the first refractive index interface 31A to become the emitted light 43A, and the rest is refracted at the first refractive index interface 31A. When the member 30A and the member 30B have the same refractive index, the light refracted at the first refractive index interface 31A is refracted again at the second refractive index interface 31B to become most of the emitted light 42A and becomes parallel to the incident light 41. Similarly, in FIG. 6, when the member 30B and the member 30C have the same refractive index, most of the emitted light 42A and most of the emitted light 42B become parallel. Although not illustrated in FIGS. 5 and 6 and FIGS. 7 to 9 to be described later for easy understanding, part of the incident light 41 is also reflected by the second refractive index interface 31B to become the emitted light 43A, and part of most of the emitted light 42A is also reflected by the fourth refractive index interface 31D to become the emitted light 43B.

Since FIG. 5 illustrates a plane including the incident light 41 incident on the first single layer film 33A in the first direction (x direction) and the first part of the emitted light 43A reflected by the first single layer film 33A in the second direction (z direction), an incident plane on the first single layer film 33A is formed. Since FIG. 6 illustrates a plane including most of the emitted light 42A incident on the second single layer film 33B in the first direction (x direction) and the second part of the emitted light 43B reflected by the second single layer film 33B in the third direction (y direction), an incident plane on the second single layer film 33B is formed. As described above, by providing the first single layer film 33A and the second single layer film 33B so that the third direction is perpendicular to the first direction and the second direction, the incident plane on the first single layer film 33A and the incident plane on the second single layer film 33B can be perpendicular to each other.

In the spatial optical system 30 illustrated in FIG. 4, as described above, since the incident plane on the first single layer film 33A and the incident plane on the second single layer film 33B are perpendicular to each other, p-polarized light in the first single layer film 33A becomes s-polarized light in the second single layer film 33B, and s-polarized light in the first single layer film 33A becomes p-polarized light in the second single layer film 33B. Since the first single layer film 33A and the second single layer film 33B have the same angle and refractive index with respect to the optical axis, the branching ratio of p-polarized light in the first single layer film 33A is equal to the branching ratio of s-polarized light in the second single layer film 33B, and the branching ratio of s-polarized light in the first single layer film 33A is equal to the branching ratio of p-polarized light in the second single layer film 33B.

When Iₚ and Iₛ indicate an intensity of the p-polarized light and an intensity of the s-polarized light in an intensity I of the incident light 41, respectively, and Kₚ and Kₛ indicate branching ratios of the p-polarized light and s-polarized light in the first single layer film 33A, respectively, the optical power entering the first light receiving element 5A is expressed by Formula 1, and the optical power entering the second light receiving element 5B is expressed by Formula 2.

$$( Math . 1 )$$

$${K}_{p} {I}_{p} + {K}_{s} {I}_{s} \qquad ( Formula 1 )$$

$$( Math . 2 )$$

$${K}_{s} ( 1 - {K}_{p} ) {I}_{p} + {K}_{p} ( 1 - {K}_{s} ) {I}_{S} \qquad ( Formula 2 )$$

From the above, the total value of the optical powers entering the first light receiving element 5A and the second light receiving element 5B is expressed by Formula 3.

$$( Math . 3 )$$

$$( {K}_{s} + {K}_{p} - {K}_{s} {K}_{p} ) ( {I}_{p} + {I}_{s} ) = ( {K}_{s} + {K}_{p} - {K}_{s} {K}_{p} ) I \qquad ( Formula 3 )$$

Since the branching ratios Kₛ and Kₚ depend only on the refractive index and the incident angle of the spatial optical system 30, the ratio of the sum of the optical powers entering the two light receiving elements 5A and 5B to the optical power of the incident light 41 is constant regardless of the polarization state.

In the optical monitoring device illustrated in FIGS. 2 and 4, the light from the incident side optical fiber 11 becomes parallel light by the incident side optical lens 21 and is prevented from being lost due to diffusion. Further, most of the emitted light 42 is guided to the emission side optical lens 22 by the spatial optical system 30. The emission side optical lens 22 collects most of the emitted light 42 that has passed through the spatial optical system 30, and couples the collected light to the emission side optical fiber 12. In this way, most of the emitted light 42 emitted from the incident optical fiber 11 can be guided to the emission side optical fiber 12 in a state where the loss is small.

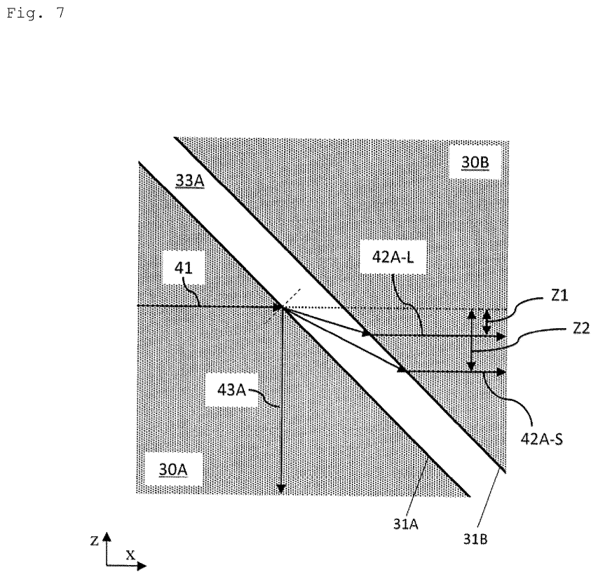

FIG. 7 illustrates a case where the incident light 41 including light of a plurality of wavelengths is incident on the first single layer film 33A. The incident light 41 travels in different directions when the wavelength is different in the single layer film 33A. Therefore, the incident position to the refractive index interface 31B differs depending on the wavelength. On the other hand, when the member 30A and the member 30B have the same refractive index, the light incident on the member 30B from the refractive index interface 33B advances in the same direction as the incident light 41 by refraction between the single layer film 33A and the member 30B. Hereinafter, in the light (most of the emitted light 42A) incident on the member 30B from the refractive index interface 33B, light with a longer wavelength is defined as most of emitted light 42A-L and light with a shorter wavelength is defined as most of emitted light 42A-S. In FIG. 7, light with a longer wavelength is assumed to have a smaller angle of refraction, but the present disclosure is not limited thereto. In this case, the optical axes of the incident light 41 and most of the emitted light 42A-L are shifted in the z direction by Z1, and the optical axes of the incident light 41 and most of the emitted light 42A-S are shifted in the z direction by Z2 (Z1<Z2).

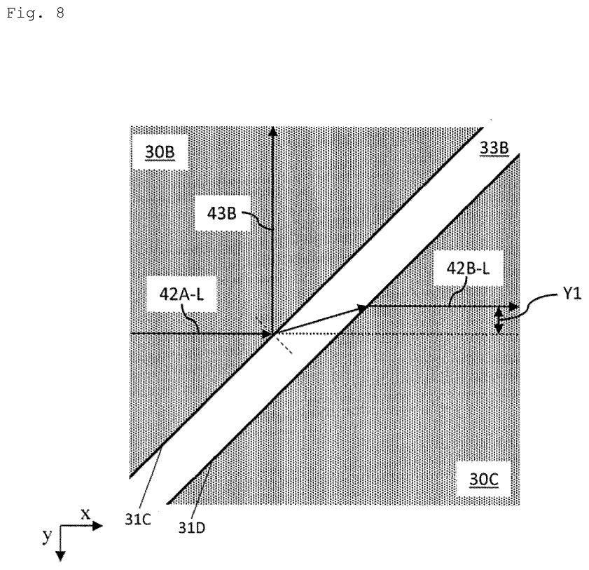

FIG. 8 illustrates a state in which most of the emitted light 42A-L illustrated in FIG. 7 is transmitted and reflected in the single layer film 33B. As described above, when the refractive indices of the member 30B and the single layer film 33B are different and the refractive indices of the member 30B and the member 30C are the same, most of the emitted light 42A-L and most of the emitted light 42B-L are parallel and the optical axes thereof are shifted in the y direction by Y1. Most of the emitted light 42B-L refers to light with a longer wavelength in most of the emitted light 42B.

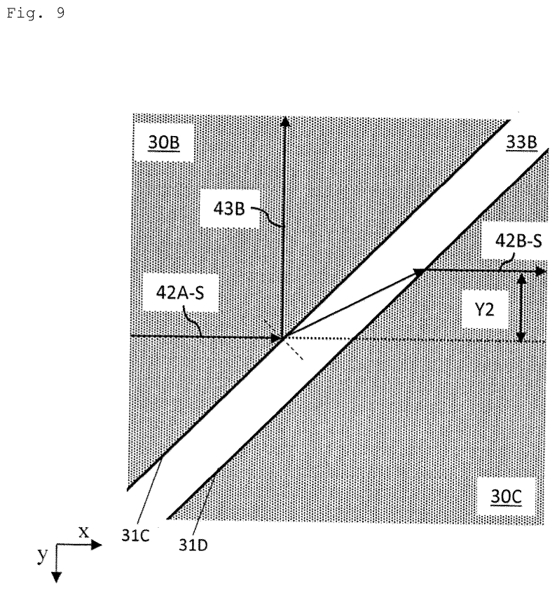

FIG. 9 illustrates a state in which most of the emitted light 42A-S illustrated in FIG. 7 is transmitted and reflected in the single layer film 33B. As described above, when the refractive indices of the member 30B and the single layer film 33B are different and the refractive indices of the member 30B and the member 30C are the same, most of the emitted light 42A-S and most of the emitted light 42B-S are parallel and the optical axes thereof are shifted in the y direction by Y2. Most of the emitted light 42B-S refers to light with a shorter wavelength in most of the emitted light 42B.

Thus, even if the optical axes at the incident end surfaces of the respective emission side optical fibers 12 are arranged in parallel, the transmitted light can be coupled to the emission side optical fibers 12 regardless of the wavelength.

However, as illustrated in FIGS. 7 to 9, the optical axes of the incident light 41 and most of the emitted light 42B are deviated. Therefore, in the present disclosure, the position and the lens diameter of the emission side optical lens 22 are determined in accordance with the wavelength range of the incident light 41. Further, as the thickness of the single layer film 33A or 33B is increased, the deviation of the optical axes of the incident light 41 and most of the emitted light 42B is increased. Therefore, the position of the emission side optical lens 22 is determined in accordance with the thickness of the single layer films 33A and 33B. Further, by setting the diameter of the emission side optical lens 22 to be equal to or larger than a value determined in accordance with the wavelength width of the incident light 41 and the thickness of the single layer films 33A and 33B, the optical loss can be reduced. On the other hand, when the diameter of the emission side optical lens 22 is equal to or larger than the installation interval of the incident side fiber, the emission side optical lens 22 collides with the adjacent lens. Therefore, it is necessary that the diameter of the emission side optical lens 22 is equal to or smaller than the installation interval of the incident side fiber.

On the other hand, part of the emitted light 43A and part of the emitted light 43B branched by the spatial optical system 30 are guided to the light receiving element 5A or 5B arranged in a direction different from most of the emitted light 42. In this way, the intensity of part of the light propagating from the incident side optical fiber 11 to the emission side optical fiber 12 can be measured.

The ratio of the sum of the optical powers measured by the two light receiving elements 5A and 5B to the intensity of the emitted light 42 is constant, and the ratio is known in advance. For example, assuming that the ratio is 1:N and the sum of the light intensities measured by the light receiving elements 5A and 5B is L [mW], it can be known that the light intensity incident from the incident side optical fiber 11 is (N+1)×L [mW], and the light intensity propagated to the emission side optical fiber 12 is N×L [mW].

As described above, in the optical monitoring device illustrated in FIGS. 2 and 4, the incident light is branched by Fresnel reflection at the refractive index interface, but since the Fresnel reflection does not depend on the wavelength and depends on the refractive index, the light can be branched in a wide wavelength range.

### First Embodiment

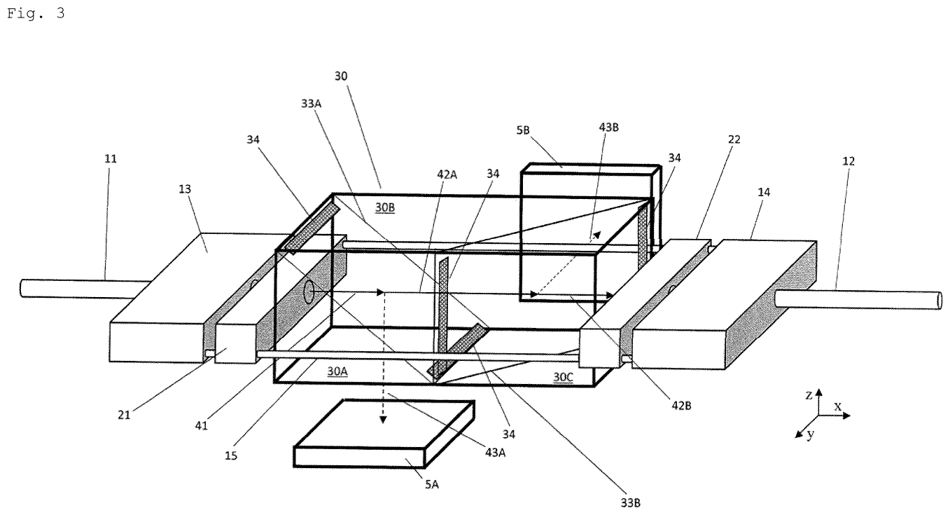

FIG. 3 illustrates an embodiment of the present disclosure. FIG. 3 illustrates only one of each of the two-dimensionally arranged incident side optical fibers 11 and emission side optical fibers 12 for easy understanding. The members 30A, 30B, and 30C can be made of quartz glass, for example. As for the first single layer film 33A and the second single layer film 33B, an air layer can be used by arranging a spacer 34 having a predetermined thickness between the respective members to form a gap. The incident side optical lens 21 and the emission side optical lens 22 can be realized by a collimator in which a GRaded INdex (GRIN) fiber is incorporated in a square ferrule 13 or 14 used in an optical connector or the like. Similarly, the optical fibers 11 and 12 are incorporated in the square ferrule 13 or 14, respectively, and the optical axes of the incident side optical fiber 11, the incident side optical lens 21, the emission side optical fiber 12, and the emission side optical lens 22 can be aligned by using a guide pin 15 and a guide hole similarly to the optical connector. The light receiving elements 5A and 5B can be realized by a commercially available optical sensor element or an optical image sensor. Unnecessary Fresnel reflection can be suppressed by filling the connection portion other than the single layer films 33A and 33B with a refractive index matching material.

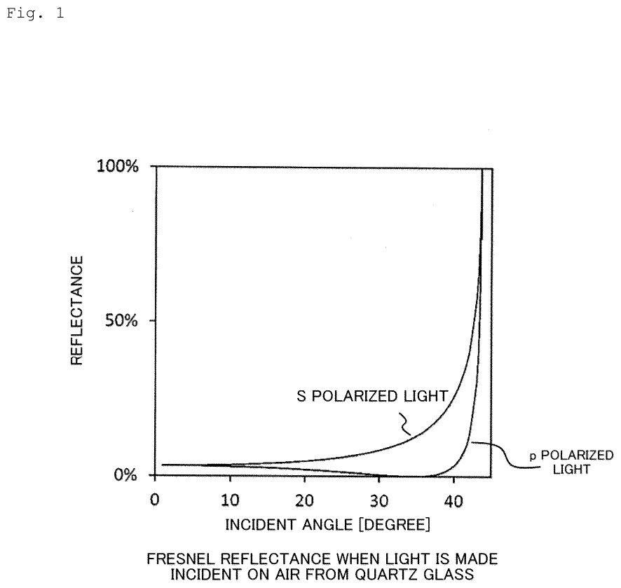

FIG. 1 illustrates the relationship between the incident angle and the reflectance of each of the s-polarized light and the p-polarized light with respect to Fresnel reflection when light is incident on the air from the quartz glass. As illustrated in FIG. 1, there is an incident angle at which the reflectance of the p-polarized light is zero. At this time, since the branching ratio of the p-polarized light branched by the single layer films 33A and 33B is also zero, when the first single layer film 33A and the second single layer film 33B are provided so that the incident angle becomes this angle, the total of the optical powers entering the first light receiving element 5A and the second light receiving element 5B is KₛI, and the relationship between the sum of the light intensities measured by the light receiving elements 5A and 5B and the power of the incident light becomes easier. For example, the first single layer film 33A and the second single layer film 33B may be provided so that the incident angle is 30 degrees or less.

According to the optical monitoring device illustrated in FIGS. 2 to 4, the incident side optical fiber 11 and the emission side optical fiber 12 are two-dimensionally arranged, and the spatial optical system 30 branches the two-dimensionally arranged light flux. As a result, there is an effect that the size can be reduced more than using an optical monitoring device for each single core or an optical monitoring device in which optical fibers are arranged one-dimensionally. Further, there is an effect that the cost can be easily reduced because the number of constituent parts is small. In addition, the power of the optical signal can be accurately monitored regardless of the polarization state of the incident optical signal.

FIGS. 2 to 4 illustrate examples in which the incident side optical fiber 11, the emission side optical fiber 12, the incident side optical lens 21, and the emission side optical lens 22 are arranged in a two-dimensional array of 3×3 is shown, but any number of combinations of 2×2 or more can be used. Further, the intervals of the two-dimensional array of the incident side optical fiber 11 and the emission side optical fiber 12 may be the same or different.

Although the embodiment has been described above, the present disclosure is not limited thereto. For example, the spatial optical system 30 is not limited to a cubic shape, but may have any shape such as a rectangular parallelepiped. Also, the light receiving element 5 can be arranged at any position where the light branched by the spatial optical system 30 can be received. For example, the light receiving element 5 may be embedded in the spatial optical system 30.

The optical monitoring device of the present disclosure can also be used for monitoring any light transmitted in an optical transmission system. For example, the optical monitoring device of the present disclosure can be mounted in any device used in an optical transmission system such as a transmitter, a receiver, or a repeater, and the measurement result at the light receiving element 5 can be used for feedback or feedforward to any component inside or outside the device. Further, the optical monitoring device of the present disclosure is inserted in the middle of a transmission line in an optical transmission system, and the intensity and propagation loss of an optical signal in the transmission line can be measured.

### INDUSTRIAL APPLICABILITY

The present disclosure can be applied to information and communication industries.

### REFERENCE SIGNS LIST

5A, 5B: Light receiving element
11: Incident side optical fiber
12: Emission side optical fiber
13: Incident side ferrule
14: Emission side ferrule
15: Guide pin
21: Incident side optical lens
22: Emission side optical lens
31: Refractive index interface
33A, 33B: Single layer film
34: Spacer
41: Incident light
42: Most of emitted light
43A, 43B: Part of emitted light
30: Spatial optical system
30A, 30B, 30C: Member

1. An optical monitoring device that detects an intensity of light propagating through a plurality of optical fibers, the optical monitoring device comprising:
a first branching portion that branches incident light incident from a determined incident area into two in a first direction and a second direction;
a first light receiving element that receives branched light branched in the second direction by the first branching portion and detects an intensity of the light branched by the first branching portion for each incident position in the incident area;
a second branching portion that branches branched light branched in the first direction by the first branching portion into two in a third direction perpendicular to both the first direction and the second direction and the first direction; and
a second light receiving element that receives branched light branched in the third direction by the second branching portion and detects an intensity of the light branched by the second branching portion for each incident position in the incident area.

2. The optical monitoring device according to claim 1, further comprising:
an optical component that has the first branching portion and the second branching portion;
a plurality of incident side optical fibers that are arranged in a two-dimensional array so as to make light incident on the incident area of the optical component;
a plurality of emission side optical fibers that are arranged in a two-dimensional array so as to receive each emitted light beam from the optical component in the first direction;
an incident side optical lens that is arranged between the optical component and the incident side optical fiber and makes each incident light beam to the optical component into parallel light; and
an emission side optical lens that is arranged between the optical component and the emission side optical fiber and couples each emitted light beam from the optical component to the emission side optical fiber.

3. The optical monitoring device according to claim 2, wherein the optical component includes
a first member that is connected to the incident side optical lens and has a uniform refractive index,
a first single layer film that is in contact with the first member and has a uniform refractive index lower than the refractive index of the first member,
a second member that is in contact with the first single layer film and has the same refractive index as that of the first member,
a second single layer film that is in contact with the second member and has a uniform refractive index lower than the refractive indices of the first member and the second member, and
a third member that is connected to the second single layer film and the emission side optical lens and has the same refractive index as that of the first member, the first single layer film functions as the first branching portion, and
the second single layer film functions as the second branching portion.

4. The optical monitoring device according to claim 3, wherein a first boundary surface between the first member and the first single layer film and a second boundary surface between the second member and the first single layer film have a specific angle with an optical axis of the incident light,
a third boundary surface between the second member and the second single layer film and a fourth boundary surface between the third member and the second single layer film have normal lines orthogonal to normal lines of the first boundary surface and the second boundary surface,
the first direction is a direction in which the light passes through the fourth boundary surface from the first boundary surface,
the second direction is a direction in which the light is reflected by the first boundary surface, and
the third direction is a direction in which the light is reflected by the third boundary surface.

5. The optical monitoring device according to claim 3, wherein a first boundary surface between the first member and the first single layer film and a second boundary surface between the second member and the first single layer film have a specific angle with an optical axis of the incident light,
a third boundary surface between the second member and the second single layer film and a fourth boundary surface between the third member and the second single layer film correspond to surfaces obtained by rotating the first boundary surface and the second boundary surface by 90 degrees in a circumferential direction around the optical axis of the incident light,
the first direction is a direction in which the light passes through the fourth boundary surface from the first boundary surface,
the second direction is a direction in which the light is reflected by the first boundary surface, and
the third direction is a direction in which the light is reflected by the third boundary surface.

6. The optical monitoring device according to claim 4,
wherein the specific angle is an angle in which a reflectance of p-polarized light of the incident light is zero.

7. The optical monitoring device according to claim 3, wherein the first single layer film and the second single layer film are air layers.
